(19) United States
(12) Patent Application Publication
(10) Pub. No.: US 2013/0012633 A1
(43) Pub. Date: Jan. 10, 2013

(54) HYBRID COMPOSITION AND MEMBRANE BASED ON SILYLATED HYDROPHILIC POLYMER

(76) Inventor: Dayue D. Jiang, Painted Post, NY (US)

(21) Appl. No.: 13/587,162

(22) Filed: Aug. 16, 2012

Related U.S. Application Data
(62) Division of application No. 12/474,592, filed on May 29, 2009.

(51) Int. Cl. C08L 79/02; C08K 5/17; C08G 73/04

(52) U.S. Cl. 524/252; 528/28; 525/56

(57) ABSTRACT

The present invention provides a method for making an organic-inorganic hybrid composition membrane comprising the steps of preparing a sol comprising at lease one silylated polyamine, casting the sol onto a surface and drying the sol to form the organic-inorganic hybrid composition membrane. The hybrid composition membrane may be used for capturing and separating CO₂ and/or H₂S from a gas sample.

This application is a Divisional of U.S. patent application Ser. No. 12/474,592 filed on May 29, 2009, the content of which is relied upon and incorporated herein by reference in its entirety, and the benefit of priority under 35 U.S.C. §120 is hereby claimed.

### FIELD OF THE INVENTION

The present invention relates generally to organic-inorganic hybrid compositions and membranes comprising a silylated hydrophilic polymer, and particularly to organic-inorganic hybrid compositions comprising a silylated polyamine.

### BACKGROUND

There are a number of industrial processes, such as coal gasification, biomass gasification, steam reforming of hydrocarbons, partial oxidation of natural gas, and like processes, which produce gas streams that include, for example, CO₂, H₂, and CO. It is frequently desirable to remove and capture CO₂ from those gas mixtures, for example, by sequestration to produce a H₂ or H₂ enriched gas product.

Therefore it would be desirable to have mechanisms or improved mechanisms to remove these gasses from gas steams. Such a mechanism may include chemical separation processes, through amino chemistry, for example. It would be particularly desirable if such a mechanism effectively captures and separates CO₂. It would also be desirable to have an efficient and cost-effective process for making the mechanism while still taking advantage of amino group chemistry.

### SUMMARY

One aspect of the invention is an organic-inorganic hybrid composition membrane comprising a network of silylated polyamine polymers. The hybrid composition membrane may be formed from a silylated polyamine through a sol-gel process. The network of silylated polyamine polymers may be achieved through formation of silica cores.

In another aspect, the present invention includes a sol for making a hybrid composition membrane where the sol comprises at least one silylated polyamine. The sol may further comprise a hydrophilic polymer, an alkoxysilane and/or a low molecular weight or an oligomeric/polymeric amine.

In a further aspect, the present invention includes a method for making an organic-inorganic hybrid composition membrane comprising the steps of preparing a sol comprising at lease one silylated polyamine, casting the sol onto a surface and drying the sol to form the organic-inorganic hybrid composition membrane. The sol may further comprise a hydrophilic polymer, an alkoxysilane and/or a low molecular weight or an oligomeric amine.

In yet another aspect, the present invention includes a method for making an organic-inorganic hybrid composition membrane-coated support comprising the steps of preparing a sol comprising silylated polyamine, depositing the sol onto a support and drying the sol on the support to form the organic-inorganic hybrid composition membrane-coated support.

In a further aspect, the present invention includes an organic-inorganic hybrid composition membrane-coated hybrid support comprising a porous ceramic support coated with an organic-inorganic hybrid composition membrane, wherein the organic-inorganic hybrid composition membrane comprises a network of silylated polyamine polymers.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1A is an illustration showing a silica core of an organic-inorganic hybrid membrane according to one embodiment of the present invention;

FIG. 1B is an illustration showing the molecular structure of the silica core of the organic-inorganic hybrid composition membrane of FIG. 1A;

FIG. 2A is an illustration showing an organic-inorganic hybrid composition membrane;

FIG. 2B is an illustration showing the silica core of the organic-inorganic hybrid composition membrane of FIG. 2A;

FIG. 3 is an illustration showing a hybrid membrane according to another embodiment of the invention; and

FIG. 4 is a scanning electric micrograph of a SPEIm/PVAAm hybrid composition-coated hybrid structure.

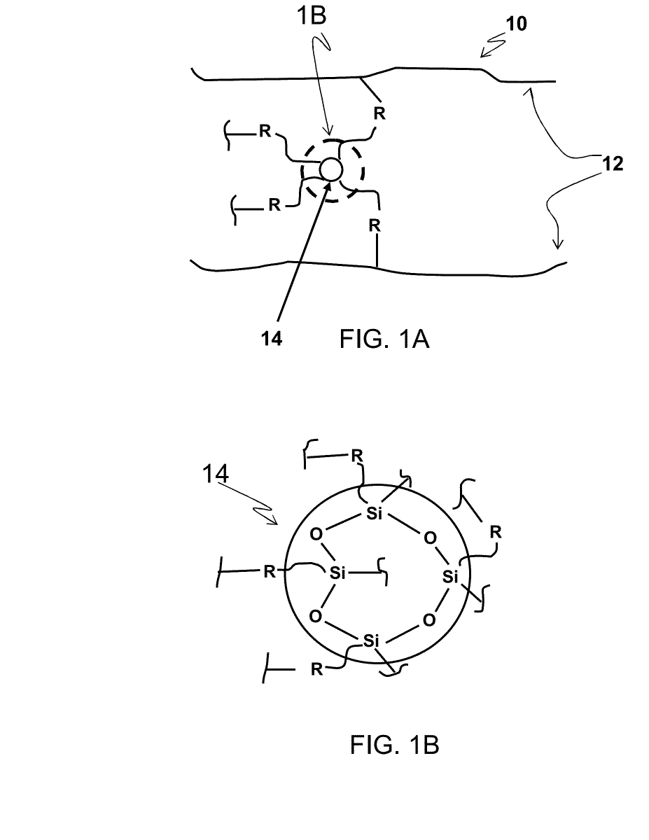

### DETAILED DESCRIPTION

Embodiments of the present invention are directed toward environmentally benign organic-inorganic hybrid sol compositions for making organic-inorganic hybrid composition membranes. Organic-inorganic hybrid membrane may comprise amino functionality, allowing it to be used to absorb gasses such as CO₂, H₂S and/or other acidic gases and separate them from gas mixtures. The organic-inorganic hybrid sol composition may comprise a silylated polyamine, such as, but not limited to, silylated polyethylenimine, (SPEIm), which works both as the precursor of a silica core formed through a sol-gel process and as the functional polymer of the hybrid composition membrane.

There are a number of technologies currently used for removing CO₂, H₂S and/or other acidic gases from gas mixtures. The most basic are amine-based gas scrubbers have an amino-alcohol such as monoethanolamine (MEA), and diethanolamine (DEA). In these scrubbers, the gas mixture is contacted with an amine-containing organic solvent or an amine-containing solution. CO₂ and other acidic molecules, such as H₂S, are selectively absorbed in the amine solution. The process takes advantage of the strong interaction between the amine, a base, and the CO₂, an acid, leading to formation of a carbamate salt.

However, there are drawbacks to this process such as high cost and inefficiencies. Membrane technology has therefore been developed making the gas separation process simpler. There are two kinds of commonly used membrane: inorganic and organic/polymeric. The inorganic membrane shows an excellent gas separation and can have both a high permeability and a high selectivity. However, large-scale applications of the inorganic membrane are still quite limited because of the poor processing ability and high cost. In contrast, the organic membranes, which are usually based on polymer(s), are cheap and easy to use, but there is often a trade-off between the permeability and the selectivity, i.e., the more permeable a membrane, the less selective, and vice versa.

Alternatively, hybrid membranes, referred to as mixed matrix membranes (MMM), having amino functionality may be used for CO₂ removal from gas mixtures. Structurally, organic-inorganic hybrid membranes consist of an organic polymer, the bulk phase, and inorganic particles non-covalently dispersed within the organic polymer. Most MMMs are currently prepared by a process of dispersing the preformed inorganic particles in the membrane formulation. However, during membrane formation there can be uncontrolled agglomeration of the inorganic particles leading to formation of membranes with packing density variations of the molecules and microstructural inhomogenities.

In contrast, embodiments of the organic-inorganic hybrid composition membranes of the present invention have a network of silylated polyamine polymers in which the inorganic moiety is attached to the organic polymer. The result is an organic-inorganic hybrid composition membrane with uniform packing densities and microstructural homogeneity that is capable of effectively capturing and separating CO₂, H₂S and/or other acidic gases from a mixture of gases. A sol comprising a silylated polyamine helps to form a membrane with uniform density and micro structural homogeneity by polymerization of the silane moiety through a sol-gel process while the amino moiety provides a functional group for capturing CO₂, H₂S and/or other acidic gases. In embodiments, the methods of the present invention also provide an efficient and cost effective process for making the organic-inorganic hybrid composition membrane.

In embodiments, methods are also provided for making an organic-inorganic hybrid composition membrane using an organic-inorganic hybrid composition sol. In embodiments, the method may comprise the steps of forming a sol comprising a silylated polyamine, casting the sol onto a surface and drying the sol to form the organic-inorganic hybrid composition membrane. The method of the present invention, in contrast to prior art methods, does not involve dispersing an inorganic particle into an organic polymer, thus avoiding agglomeration of the inorganic particles. The sol may be cast onto a support to provide an organic-inorganic hybrid composition membrane-coated structure that may be used for molecular separation, particularly CO₂, H₂S or another acidic gas capture from gas streams containing CO₂, H₂S or other acidic gases.

The sol-gel process is a wet-chemical technique well known in the art. It begins with a chemical solution or suspension, the “sol,” which acts as a precursor for an integrated network, or “gel” of network polymers. The sol has the monomeric units (i.e. the silylated polyamine of the present invention) and may also have other desired components of the final gel either in solution or as a suspension of submicron particles. The sol-gel process is a dynamic process where polycondensation begins in the sol and proceeds to a gel point. At the gel point, the polymerization is so extensive that it cannot be poured. The sol is cast or deposited before the gel point and polycondensation continues to the gel point after the sol is cast or deposited, particularly as it begins to dry and the sol becomes concentrated. Polycondensation may continue past the gel point, creating a stiffer gel.

In one embodiment of the invention there is provided a method for making an organic-inorganic hybrid composition membrane. The method may comprise the steps of preparing a sol comprising at least one silylated polyamine and an aqueous solvent, casting the sol onto a surface and drying the sol to form the organic-inorganic hybrid composition membrane. The silylated polyamine may function both as the precursor to the silica core as well as the functional polymer where the amino-moieties bind or absorb the CO₂ and/or H₂S. The silylated polyamine may be, but is not limited to, silylated polyethylenimine, silylated polyvinylpyridine, silylated polydimethylaminoethylmethacrylate, silyated polyvinylamine or combinations thereof. In an illustrative embodiment, the silylated polyamine is trimethoxysilylpropyl modified polyethylenimine, silylated polyethylenimine (SPEIm). The sol may comprise from about 5 wt % to about 40 wt % (or higher) of the silylated polyamine. In an illustrative embodiment, the sol may comprise from about 10 wt % to about 20 wt % of the silylated polyamine. It is well known in making sol solutions that the concentration of the silylated polyamine may be such so that the sol does not begin to gel before being cast or deposited on a substrate. The working time for a sol will depend on the silylated polyamine being used as well as concentration and temperature. Those skilled in that art will be able to determine the best concentration for forming a gel from a sol without undue experimentation.

In one embodiment of the invention there is provided a method for making an organic-inorganic hybrid composition membrane. The method may comprise the steps of preparing a sol comprising at least one silylated polyamine and an aqueous solvent, casting the sol onto a surface and drying the sol to form the organic-inorganic hybrid composition membrane. The silylated polyamine may function both as the precursor to the silica core as well as the functional polymer where the amino-moieties bind or absorb the CO₂ and/or H₂S. The silylated polyamine may be, but is not limited to, silylated polyethylenimine, silylated polyvinylpyridine, silylated polydimethylaminoethylmethacrylate, silyated polyvinylamine or combinations thereof. In an illustrative embodiment, the silylated polyamine is trimethoxysilylpropyl modified polyethylenimine, silylated polyethylenimine (SPEIm). The sol may comprise from about 5 wt % to about 40 wt % (or higher) of the silylated polyamine. In an illustrative embodiment, the sol may comprise from about 10 wt % to about 20 wt % of the silylated polyamine. It is well known in making sol solutions that the concentration of the silylated polyamine may be such so that the sol does not begin to gel before being cast or deposited on a substrate. The working time for a sol will depend on the silylated polyamine being used as well as concentration and temperature. Those skilled in that art will be able to determine the best concentration for forming a gel from a sol without undue experimentation.

Likewise, the choice of aqueous solvent may be dependent on the silylated polyamine(s) comprising the sol. By way of non-limiting example, SPEIm may be in aqueous isopropanol. The aqueous solvent may be chosen based on the solubility characteristics of the desired silylated polyamines. Other examples of aqueous solvents may be short alkyl chain alcohols such as methanol and ethanol, either alone or in combination with water.

The sol can be either cast onto a surface to form a film (e.g., by dip-coating or spin-coating), cast into a suitable container with the desired shape (e.g., to obtain monolithic ceramics, glasses, fibers, membranes, aerogels), or used to synthesize powders, microspheres, or nanospheres. In one embodiment of the present invention the sol is cast on a support to produce an organic-inorganic hybrid composition membrane-coated structure. The support may be, but is not limited to, a ceramic support. The material and shape of the substrate will depend on the use of the final product. Some applications may require a small and simple substrate whereas other applications, i.e. diesel engines or commercial preparation of gases, may require larger, more complex substrates such as ceramic honeycomb supports. Ceramic honeycombs are well known in the art and may be made of cordierite, mullite, aluminum titanate or aluminum. It will be appreciated that the shape and composition of the support may be of any material and shape desired by the skilled artisan.

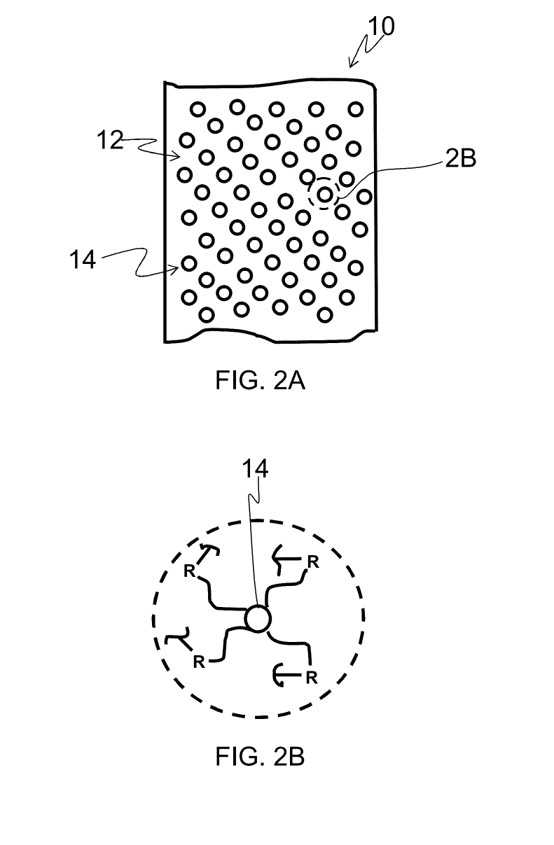

Once the sol is cast on the desired surface and/or support, the sol and/or subsequent resulting gel may be dried removing the remaining liquid (solvent). As described above, the sol-gel process is a dynamic process and drying the sol may hasten the onset of the gel point. The drying process may be accompanied by a significant amount of shrinkage and densification. The rate at which the solvent can be removed is ultimately determined by the distribution of porosity in the gel. The ultimate microstructure of the final component will clearly be strongly influenced by changes imposed upon the structural template during this phase of processing. In one embodiment of the present invention, the casted sol is dried at room temperature for at least 6 hours or from about 6 hours to about 21 days to form the organic-inorganic hybrid composition membrane. In an additional embodiment, the sol is further dried at 50° C. to about 70° C. for at least 2 hours. FIG. 2A illustrates the organic-inorganic hybrid composition membrane 10 showing the polyamine polymer phase 12 and the silica core 14. FIG. 2A shows an expanded view of the silica core 14. FIG. 2B shows an expanded view of a silica core 14 of the organic-inorganic hybrid composition.

In embodiments, the sol, and subsequently the organic-inorganic hybrid composition membrane, may further have at least one hydrophilic polymer. The sol may have from about 5 wt % to about 25 wt % of the hydrophilic polymer where the hydrophilic polymer is an alcohol-based polymer or an amino-functionalized alcohol polymer. Non-limiting examples of alcohol-based polymers may be poly(vinyl alcohol) (PVA) or poly(allyl alcohol) (PAA), poly(hydroxyethyl methacrylate) (PHEMa) or combinations thereof. Non-limiting examples of the amino-functionalized alcohol polymer may be poly(vinyl alcohol-co-vinylamine) (PVAAm), poly(vinyl alcohol-co-allylamine) (PVAAAm), poly(aminoprolyl methacrylamide-co-hydroxyethyl methacrylate) (PAPMa-co-HEMa) or combinations thereof. The presence of the hydrophilic polymer may increase the strength of the organic-inorganic hybrid composition membrane. The hydrophilic polymer may be distributed throughout the gel as it is formed and subsequently, the organic-inorganic hybrid composition membrane. It may interact with the silylated polyamine through ionic bonding, hydrogen bonding or by Vander Waal forces. However, it is not necessary that the hydrophilic polymer interact with the silylated polyamine. Optionally, the hydrophilic polymer may be crosslinked to the polyamine either chemically, by radiation or UV, or thermally. It may be crosslinked in the sol or after the gel is formed. If the hydrophilic polymer is an amino-functionalized alcohol polymer, it may not only aid in forming a stronger membrane but also provides additional amine functionality for adsorbing CO₂.

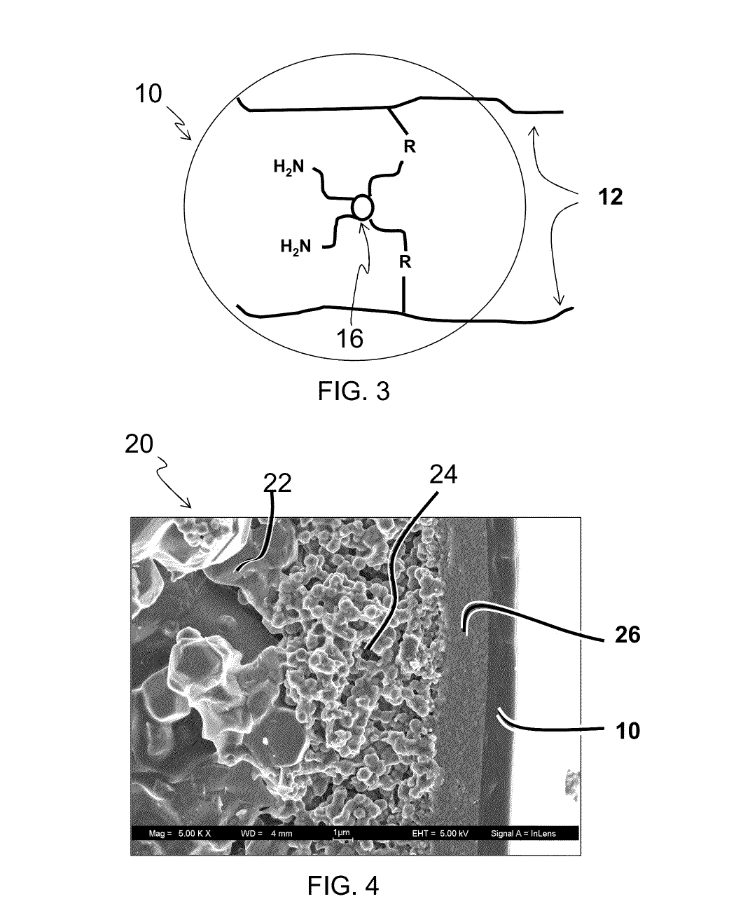

In further embodiments of the present invention, the sol, and subsequently the organic-inorganic hybrid composition membrane, may also have at least one alkoxysilane. In illustrative embodiments, the alkoxysilane may be an amine-functionalized alkoxysilane such as, but not limited to, aminopropyltriethoxysilane (APTEOS), (3-trimethoxysilylpropyl)diethylenetriamine (TMSPDETA) or combinations thereof. The amine-functionalized alkoxysilanes can form amino-functionalized silica particles through the formation of a silica core as described above for the silylated polyamine. The alkoxysilanes along with the silylated polyamines may form a heterogeneous silica core having both compounds. FIG. 3 illustrates a heterogeneous silica core 16 formed from an amine-functionalized alkoxysilane and a silylated polyamine to form an organic-inorganic hybrid composition 10 having a polyamine polymer phase 12 and a silica core 16.

In yet further embodiments, the sol, and subsequently the organic-inorganic hybrid composition membrane, may have at least one low molecular weight or oligomeric/polymeric amine. Non-limiting examples of low molecular weight amines may be tetraethylenepentamine, ethylenediamine or combinations thereof, and non-limiting examples of oligomeric/polymeric amines may be polyvinylamine, polyallylamine or combinations thereof. The addition of the amine may increase the capacity of the organic-inorganic hybrid composition membrane to capture and separate CO₂ and/or H₂S.

The present invention also provides a method for using the organic-inorganic hybrid composition membrane-coated support of the present invention to capture and separate CO₂, H₂S and/or other acidic gases from a gas sample/stream. The method may include the step of flowing a gas through and/or over the organic-inorganic hybrid composition membrane-coated support. The CO₂, H₂S and/or other acidic gases may be bound to the amine groups through hydrogen bonding and a weak ionic attraction. The method may further include the step of releasing the CO₂, H₂S and/or other acidic gases from the organic-inorganic hybrid composition membrane-coated structure. Methods are known in the art including, but not limited to, applying a charge to the hybrid composition-coated structure or interfering with the charge attraction. It may be desirable to capture and separate CO₂, H₂S and/or other acidic gases in order to purify a gas. Alternatively, CO₂, H₂S and/or other acidic gases may be separated and collected for other uses. For example, CO₂ is a major product in producing bio-ethanol. The CO₂ is captured and isolated and subsequently used for example, to carbonate beverages or to make dry ice.

### EXAMPLES

The invention will be further clarified by the following examples.

### Example 1

### Preparation of SPEIm Membrane and Making the Membrane

Two methods were used to prepare a silylated polyethylenimine (SPEIm) membrane. One was to use a 15 wt % isopropanol solution of SPEIm, forming the hybrid coating/membrane by casting the solution onto a glass substrate and drying at room temperature in a hood for 6 hours and then at 60° C. for 2 hours. The other method was to form an aqueous solution of SPEIm by adding 1.0 g of a 50 wt % SPEIm/isopropanol solution to 4.0 g water. A clear solution resulted after mixing well and was cast on a glass substrate, dried at room temperature in a hood for 6 hours and then at 60° C. for 2 hours.

A solubility test was conducted in water for a SPEIm membrane obtained by casting 15% isopaopanol solution on a glass substrate and cured at room temperature for 3 weeks. The SPEIm membrane on the glass substrate was placed in water, up to half immersed. A swelling of the SPEIm membrane was observed, indicative of the formation of the Si—O—Si links. This supports the formation of the silica core and the networked structure of the SPEIm coating/membrane.

### Example 2

### Preparation of PVAAm Aqueous Solution

A 1000 ml Mason jar was charged 549.0 g deionized (DI) water and then placed into a 85° C. hot glycol bath. A mechanical stirrer was then installed and with stirring set to 300 rpm, the jar was charged 51.0 g poly(vinyl alcohol-co-allylamine (PVAAm) resin (Erkol L12, Celanese). Stirring speed was gradually increased up to 600 rpm and maintained for 2 hours. The Mason jar was then removed from the hot bath and the resulting solution was filtered by passing through a blue paper towel to remove the insoluble residue. The filtered solution was cooled to room temperature.

### Example 3

### Preparation of SPEIm/PVAAm Hybrid Formulation and Membrane

It should be noted that the SPEIm/PVAAm can be at any ratio. In this example an aqueous solution of SPEIm/PVAAm at a ratio of around 1/1 (wt/wt) was used. A 20 ml vial was charged 5 g of the 8.0 wt % PVAAm aqueous solution prepared in Example 2, 0.8 g of a 50 wt % SPEIm isopropanol solution and 2.0 g water and mixed well with shaking and/or stirring. The solution was clear and remained clear. A SPEIm/PVAAm coating/membrane was obtained by casting the solution on a glass substrate, drying at room temperature in a hood for 6 hours and then at 60° C. for 2 hours.

### Example 4

### Coating SPEIm/PVAAm Hybrid Composition onto Ceramic Monolith

The ceramic monolith substrate used was made of alpha-alumina with an outer diameter of about 9.7 mm and with 19, 0.8-mm rounded channels uniformly distributed over the cross-sectional area. It had a mean pore size of about 10 μm, a porosity of about 45% and was modified with coating layer of alpha-alumina and then gamma-alumina on the channel surface. The mass of the dried ceramic monolith was measured and then it was wrapped with the Teflon tape and the mass measured again. On one end of the ceramic monolith a pseudo vacuum system (syringe) was connected. The other end of the ceramic monolith was soaked in the SPEIm/PVAAm aqueous solution prepared in Example 3 while withdrawing the solution with the syringe. After the solution from the end connected to the syringe was evacuated for 10 seconds, the solution was pushed out and the ceramic monolith connected to a N₂ source to remove the extra solution from the channels of the ceramic monolith. The coated ceramic monolith was dried at room temperature for over night and then put into a dryer, which was preheated to 80° C. for 4 hours. After cooling to room temperature, the mass was measured again to obtain the weight gain.

FIG. 4 shows a scanning electromicrograph image of the hybrid composition-coated structure 20 having the porous ceramic monolith 22, a coating layer of alpha-alumina 24, a coating layer of gamma-alumina 26 and the hybrid composition membrane 26.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

### Example 5

### CO₂ Capture Test

The CO₂ capture capacity of SPEIm was evaluated using a qualitative CO₂ capture test. A 15 wt % solution of SPEIm in an aqueous system was prepared. The solution was applied to glass wool filter paper as the substrate and then dried overnight at room temperature followed by 100° C. for 15 minutes. The weight of the filter paper was measured before and after the solution was applied. Based on the weight gain (difference), about 60 wt % of the SPEIm was attached to the glass wool filter paper.

The resulting SPEIm-glass wool filter paper was evaluated for its ability to absorb CO₂. The SPEIm-glass wool filter paper was placed in a humidified CO₂ atmosphere for about 30-60 minutes and then in water, where a gentle bubbling was observed. Next, a few drops of a Ba(OH)₂ saturated solution was added to the water. The SPEIm-glass wool filter paper was gently stirred for 15 minutes, resulting in a cloudy appearance due to the formation of finely dispersed insoluble BaCO₃. When a control SPEIm-glass wool filter that was not exposed to the humidified CO₂ atmosphere was also evaluated with the Ba(OH)₂, a light cloudy appearance was also observed because of the silica core formed during the sample preparation. However, the cloudy appearance of the control was significantly less than the sample exposed to the humidified CO₂ atmosphere.

Alternatively, the glass wool filter paper was dried overnight after the CO₂ capture test. The ˜60% SPEIm-filter paper, by mass difference, had a weight gain of ˜9.7%, after the CO₂ capture test and drying at room temperature for over night.

The phenomenon of gently bubbling, the Ba²⁺ test and the weight gain confirm that SPEIm has a capability to capture CO₂. Combined with the ability to form a silica core, SPEIm can be used as membrane material for CO₂ separation.

1. Use of an organic-inorganic hybrid composition membrane comprising silylated polyethylenimine, silylated polyvinylpyridine, silylated polydimethylaminoethylmethacrylate, silylated polyvinylamine or combinations thereof for separating CO₂ or H₂S from gas streams.

2. (canceled)

3. (canceled)

4. Use of the membrane of claim 1 wherein the membrane further comprises at least one hydrophilic polymer.

5. Use of the membrane of claim 4 wherein the hydrophilic polymer comprises poly(vinyl alcohol-co-vinylamine), poly(vinyl alcohol) or combinations of poly(vinyl alcohol-co-vinylamine) and poly(vinyl alcohol).

6. (canceled)

7. Use of the membrane of claim 1 wherein the membrane further comprises at least one low molecular weight amine wherein the low molecular weight amine comprises tetraethylenepentamine, ethylenediamine or combinations of tetraethylenepentamine and ethylenediamine.

8.-20. (canceled)
